(19) United States
(12) Patent Application Publication
(10) Pub. No.: US 2003/0121191 A1
(43) Pub. Date: Jul. 3, 2003

(54) Customizable back lighted sign

(76) Inventors: Jeffrey M. DeJarnette, Rutland, VT (US); Jeffrey R. Lloyd, Rutland, VT (US)

Correspondence Address: KEVIN ELLICOTT, ESQ, SUITE 112, 1 SCALE AVE, RUTLAND, VT, 05701, US

(21) Appl. No.: 10/271,504

(22) Filed: Oct. 16, 2002

Related U.S. Application Data
(60) Provisional application No. 60/343,959, filed on Jan. 2, 2002.

(51) Int. Cl. G09F 13/04

(52) U.S. Cl. 40/576

(57) ABSTRACT

A customizable back lighted sign comprising a hollow box-like body having an open side, an illumination source mounted within the body and electrically connected to a power source, a removable cover plate and lens mounted on the body and covering the open side, and thin sheet-like material having visible thereupon data such as numbers and letters and opaque background against which the data is highly visible, the thin sheet-like material being attached to the lens, the data being highly contrasted against the background while at the same time permitting the passage therethrough of light produced by the illumination source from within the box-like body.

### B CROSS REFERENCE TO OTHER APPLICATIONS

This is a non-provisional application claiming priority of Provisional Application No. 60,343,959 filed Oct. 23, 2001.

### C FEDERALLY SPONSORED RESEARCH AND DEVELOPMENT

There are no federally sponsored or funded research or development projects or undertakings in any way associated with the instant invention.

### D BACKGROUND OF THE INVENTION

1. Field of the Invention

The instant invention relates to that field of devices consisting of articles of manufacture known as lighted signs. Specifically, the instant invention is a lighted sign having a lighted area for displaying user configured communications such as words, addresses and other data and graphics.

2. Background Information

The prior art known to the Inventors discloses that the basic lighted sign is well known. Variations of the sign include the front lighted sign, the back lighted sign, and the edge lighted sign.

The instant invention is of the sort generally referred to as a back lighted sign. In the prior art, the back lighted sign is usually composed of a hollow box-like body having an opening passing completely through a side. An illumination source for the back lighted sign is normally mounted within the hollow box-like body such that the illumination is visible through the open side, and a cover and/or lens having translucent portions and opaque portions is attached to the box-like body in such a fashion as to cover the opening and obscure the illumination source from direct view while permitting light produced by the illumination source to pass through the translucent lens portion.

The prior art back lighted sign most often was used to convey information (serve as a communication means) in darkened situations. A fine example of such a prior art sign is the “EXIT” sign commonly found in most public buildings. The so-called EXIT sign was usually constructed of a rigid, box-like body having a rigid cover or lens which had the word EXIT incised into it such that when the cover/lens was mounted against the open side of the box-like body having an illumination source therewithin, light emanating from the illumination source would pass through the lens portion and incised EXIT and shine out of the box, making the word EXIT visible in darkened conditions. A theme variant upon the aforementioned exit sign included a translucent, colored film which was applied to the lens portion and completely covered the incised word EXIT. Most often, this film was red in color. Once illuminated, the incised word EXIT would appear red as a result of the red-colored light shining through the lens portion.

In another variation found in the prior art, the cover or lens used in conjunction with the back lighted box-like body would be fabricated in such a fashion as to permanently convey specific and particular information. The best known example of this particular form of back lighted sign is the back lighted “business sign”. The back lighted business sign generally includes a conventional back lighted, hollow box-like body and a cover plate and/or lens having thereupon information (e.g. words, numerals, graphic pictures, logos and the like) which, when the illumination source is operating under darkened conditions, would allow information to be seen at a distance. This is perhaps the most widely known form of back lighted sign in use today, and may be seen on display along practically any road upon which businesses are located which desire visibility for their signs at night.

Unfortunately, both of the prior art back lighted signs described above require that the information transmitted by the sign is fabricated into or onto the lens/cover at the time of manufacture. In the case of the EXIT sign, the word EXIT is incised through the lens/cover thereby rendering the lens/cover useless for any purpose or to convey any information other than EXIT. So too, back lighted business signs often have the information to be presented by the sign placed permanently and irremovably into or onto the lens/cover. Frequently this is accomplished by painting, embossing or engraving the lens/cover with the information/design.

And while such a permanent attachment of the information/design to the lens may be precisely what is desired for an EXIT sign or a business sign, the inventors have discovered that it is extremely undesirable when such a back lighted sign is to be used by a consumer or home owner. It has been discovered that there is a long-felt need for a back lighted sign which may be configured by the user to convey whatever information is most useful to that user.

The inventors have found that there is a great deal of demand for one particular embodiment of the instant invention; the lighted address sign. This demand has been increased greatly by the implementation of various so-called “911” systems in use by many towns and cities. This system creates a correspondence between the numbering of a house, and its physical location on a particular street. For example, a house which is located approximately ½ of one mile down a street would be house number 500, while another house which is one mile down that same street would be house number 1000. It is believed that this will assist rescue, hospital and police and other emergency services personnel with quickly locating a house in the event of an emergency. But despite this correspondence between distance and house numbering, the new system is practically useless if the house to be reached does not have in plain sight, and relatively close proximity to the house, a clearly visible number which my be easily seen both during the day and at night.

Therefore, use of the instant invention as a house numbering device will clearly solve this unmet need. However, while this may be the most straightforward use for the instant invention, it could just as easily provide the means for many other sorts of communication including, but not limited to, the written expression of opinions, phone numbers and descriptions of other interests. For example, a user would finally have the ability, found nowhere in the prior art, to use a MYLAR sheet (or other thin, clear sheet-like material) in the photocopying process to create a graphic art form comprised of translucent and opaque portion which could easily be mounted onto the lens and thereby fabricate a custom lighted sign both inexpensively and easily. In the prior art, the only way in which this might be accomplished would have been to contact a custom sign manufacturer and invest sizable sums of money into having a custom lens/cover created. Furthermore, by utilizing an adhesive which is removable when mounting the graphic art to the lens, it would be entirely possible for the user to later remove the design and create a new one, without having to purchase an additional back lighted sign.

While the back lighted address sign described above is in itself a complete and useful invention, the inventors have further learned that such a sign may incorporate additional features which greatly increase its value to potential users. For example, the basic back lighted address sign described above must be supplied with power in order for the illumination source to produce light. This may be accomplished through any conventional power generating means such as household current (whether direct or alternating current,) electricity producing solar panels, and batteries, to name a few. Perhaps the easiest means for providing power to the illumination source is by using as the illumination source a light fixture and bulb having a commonly available two prong or DUPLEX plug which may be inserted into an electrical outlet. However, such an arrangement will often result in the illumination source being powered both day and night, as it is quite common for users of such a device to unplug it once the ambient lighting conditions are essentially lightened (e.g. during daylight hours). This in turn leads to failure of the illumination source more quickly than if the power to the illumination source is discontinued when not needed during the day.

To avoid early failure of the illumination source within the device, the inventors believe it is useful to incorporate a light-activated switch (e.g. a light sensitive, or photo-voltaic switch set to interrupt the flow of power to the illumination source during daylight hours) which would turn the back lighted sign off when ambient light is striking the switch.

Another useful component of the back lighted address sign embodiment of the instant invention is a strobe light having a manually operated switch, both the manually operated switch and the strobe light being mounted preferably within the box-like body such that the switch may be easily tripped by a user, and the strobe light may be easily seen at a distance. When used as a house numbering sign, the inclusion of a strobe light would prove incredibly valuable in assisting emergency personnel to quickly locate the house, first by seeing the strobe light more quickly than other forms of lighting, and second, by having the lighted number sign to quickly confirm that the correct house has been reached.

Finally, it should be noted that while the strobe light may be activated by a manual switch, the inventors believe that a commonly available remote activation switch could be substituted for the manual switch, providing the user of the device with the ability to activate the strobe in the event of an emergency, within the range of the remote activation switch, and without having to manually activate the strobe light.

### E SUMMARY OF THE INVENTION

The instant invention is a fully customizable back lighted sign. For the first time, a user may quickly and efficiently prepare a custom made back lighted sign which may later be changed or modified at his or her discretion.

A first object of the instant invention, therefore, is to provide for a back lighted sign which may be custom configured by a user.

This objective is accomplished by fabricating a back lighted sign comprising a substantially rigid box-like body having an open side, an illumination source mounted within the box-like body, a cover and/or lens for communicating light from within the box-like body to the external environment beyond the interior of the box-like body, and data composed of transparent or translucent portions through which light within the box may pass and opaque portions for preventing the passage of light from within the box-like body therethrough.

A second objective of the invention is to provide a back lighted address sign capable of communicating residential and/or business address information over a distance in darkened ambient light conditions.

This objective is accomplished by fabricating a back lighted sign comprising a substantially rigid box-like body having an open side, an illumination source mounted within the box-like body, a cover and/or lens covering the open side for communicating light from within the box-like body to the external environment, and thin sheet-like material having imprinted thereupon letters and/or numerals or other data such as graphic designs, the letters and/or numbers being transparent or translucent, the remaining portion of the sheet-like material being opaque.

A third objective of the invention is to provide a back lighted sign which may be custom configured by a user and which includes an emergency notification component.

This objective is accomplished by fabricating a back lighted sign comprising a substantially rigid box-like body having an open side, an illumination source mounted within the box-like body, a cover plate and/or lens covering the open side for communicating light from within the box-like body to the external environment, thin sheet-like material having imprinted thereupon data such as letters and or/numerals or graphic designs, the data being transparent or translucent, the remaining portion of the sheet-like material being opaque, a strobe light mounted on the box-like body or preferably, within the box-like body, and a switch for supplying said strobe light with power to activate said strobe light, the switch being mounted upon the back lighted sign such that it may be easily activated by the user either manually or remotely via a remotely activatable type switch.

A fourth objective of the invention is to provide a back lighted sign which may be custom configured by a user and which includes means for automatically turning the illumination source on and off in response to ambient lighting conditions.

This objective is accomplished through the incorporation of a photo-voltaic cell connected to the power source and the illumination source such that power is supplied to the illumination source when the ambient light conditions are essentially darkened (e.g. at night), and power is discontinued to the illumination source when ambient light conditions are essentially lightened (e.g. during the day).

A fifth objective of the invention is to provide a back lighted sign which may be custom configured by a user and which may be easily read at a distance under both darkened and lightened ambient lighting conditions.

This objective is accomplished by fabricating a back lighted sign comprising a substantially rigid box-like body having an open side, an illumination source mounted within the box-like body, a cover plate and/or lens covering the open side for communicating light produced within the box-like body to the external environment (that is, light shining out of the box-like body), thin sheet-like material attached to the lens and having imprinted thereupon data such as letters, numerals, and/or graphic designs, the data being transparent or translucent, the remaining portion of the sheet-like material being opaque, the opaque portion of the sheet-like material serving as a darkened background against which the transparent or translucent portion (the portion communicating the information represented by the data) is highly contrasted and thus may be easily seen during daylight hours (even without the illumination source producing light) and night time hours (when the illumination source may be producing light which shines through the transparent or translucent portion of the sheet-like material), the data therefore being visible without the aid of an external light source such as a flashlight or vehicle headlight/spotlight.

### F A DESCRIPTION OF THE DRAWINGS

FIG. 1 is a perspective view of the preferred embodiment of the instant invention.

FIG. 2 is a front elevational view of the instant invention with the cover plate and lens removed.

FIG. 3 is a close up perspective view of a top portion of the box-like body showing an embodiment of the cover plate attachment means.

FIG. 4 is a close up perspective view of top portion of the cover plate showing an embodiment of the clover plate attachment means.

FIG. 5 is a front elevational view of an embodiment of the box-like body having an open front side and an open rear side.

FIG. 6 is a front perspective view of an embodiment of the box-like body having an open front side and an open rear side.

FIG. 7 is a front elevational view of a second cover plate.

FIG. 8 is a front elevational view of the cover plate having device mounting means attached.

FIG. 9 is a front elevational view of the lens having thin sheet-like material thereupon.

### G A DESCRIPTION OF THE PREFERRED EMBODIMENT

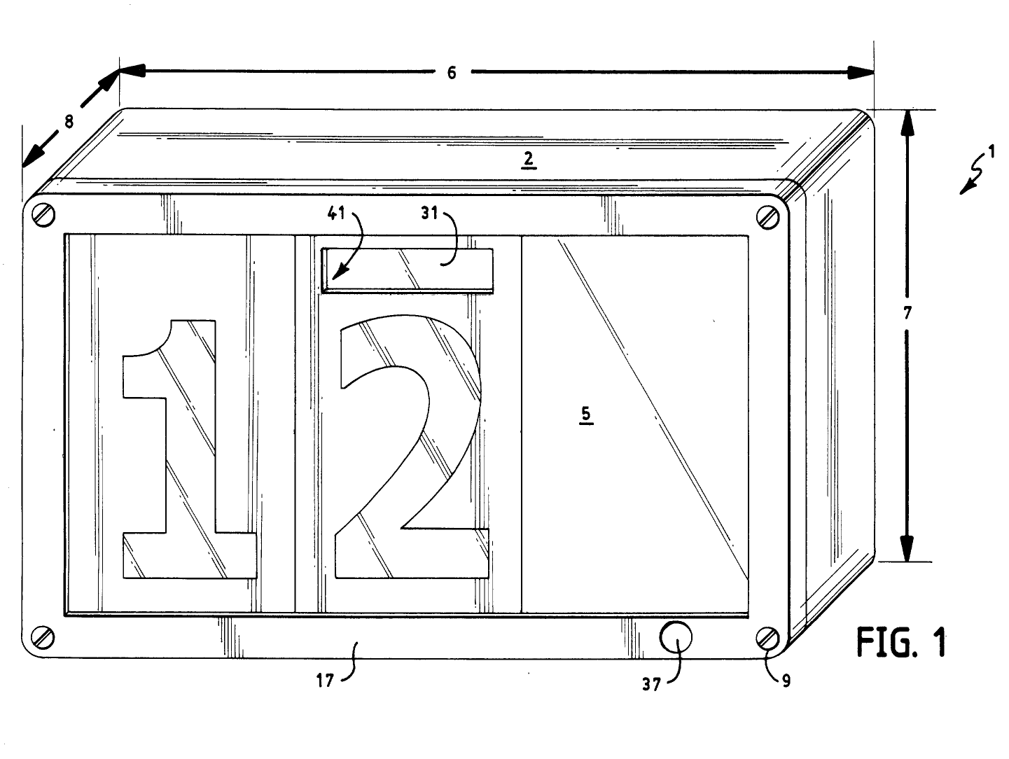

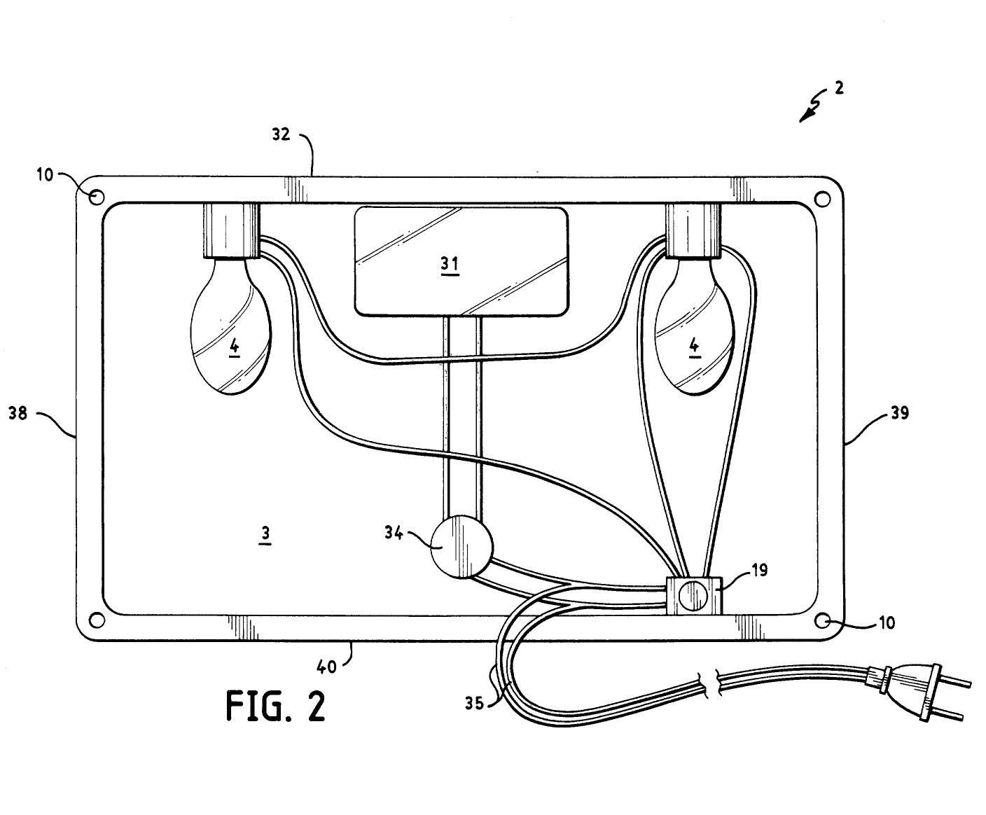

As per FIGS. 1 and 2, a customizable back lighted sign (1) comprises, in the preferred embodiment, a solid walled, hollow interior, box-like body (2) having an open side (3), a left side (38) adjacent to the open side, a right side (39) adjacent to the open side and opposite and spaced apart from the right side, a top side (32) adjacent to both the right side and left side, and a bottom side (40) adjacent to both the right side and left side, and opposite and spaced apart from the top side. Each “side” is a side wall of the box-like body. At least one illumination source (4) is mounted within the hollow interior of the box-like body such that when the illumination source is in fact giving off light, that light will shine outwardly and through the open side (3). Hollow, box-like bodies are well known throughout most art fields, being generally accepted as having spaced apart walls defining the hollow interior (in much the same manner as does a 6 sided, hollow, three dimensional box).

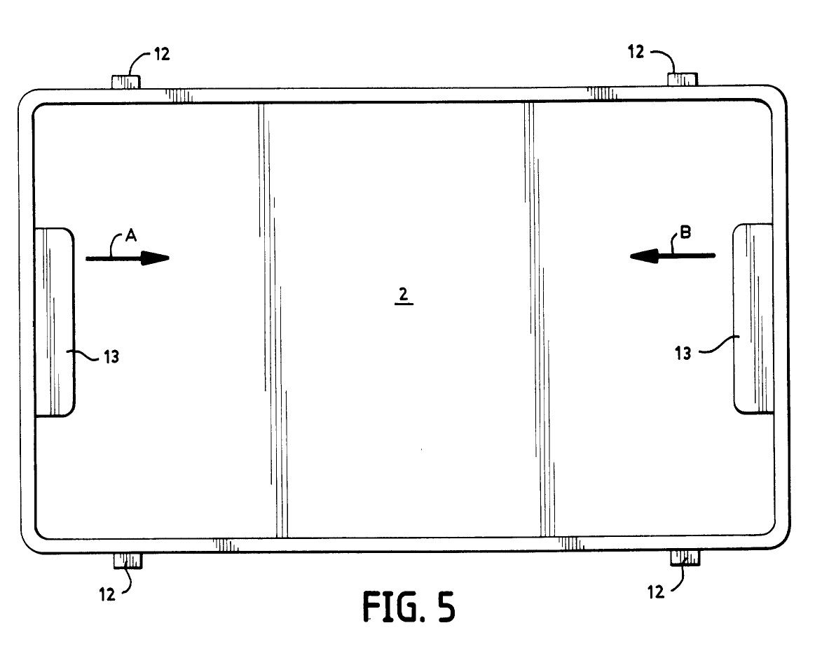

The customizable back lighted sign further has a cover plate (17) and a lens (5), the cover plate being sized and shaped for completely covering the open side (3). The cover plate is removably attached to the box-like body (2) such that it may be removed, and access to the box-like body hollow interior may be had in the event that the illumination source may be accessed, for example. The lens (5) is preferably translucent, and the cover plate (17) is preferably opaque. The cover plate and lens may be of one piece, or constructed from two separate parts. When the cover plate and lens are constructed from two separate parts, the cover plate may easily be thought of as a “frame” through which the lens is visible and which borders and retains the lens. Furthermore, when the cover plate and lens are constructed from two separate parts, and not permanently attached to one another, it is necessary to fabricate the box-like body (2) such that the side of the lens which faces the illumination source, when fully assembled, is sufficiently supported so that it will not shift from side to side or forward to backward when being handled or after mounting the completed device for use. This may easily and obviously be accomplished, as per FIG. 5, by including supports (13) within the hollow interior of the box-like body. The supports (13) may be as simple as a pair of flattened portions of the box-like body extending into the hollow interior of the box-like body, toward one another, in the direction indicated by arrow A and arrow B, respectively. The flattened portions should be shaped and dimensioned such that when the lens is placed flat against the flattened portion, and the cover plate is placed over the lens and assembled onto the box-like body, the lens will be firmly retained between the flattened portions and the cover plate. Again, this is but one possible configuration of the instant invention, and the instant invention will function as desired by the inventors so long as the cover plate and lens portion may be firmly, but preferably removably, attached to the box-like body.

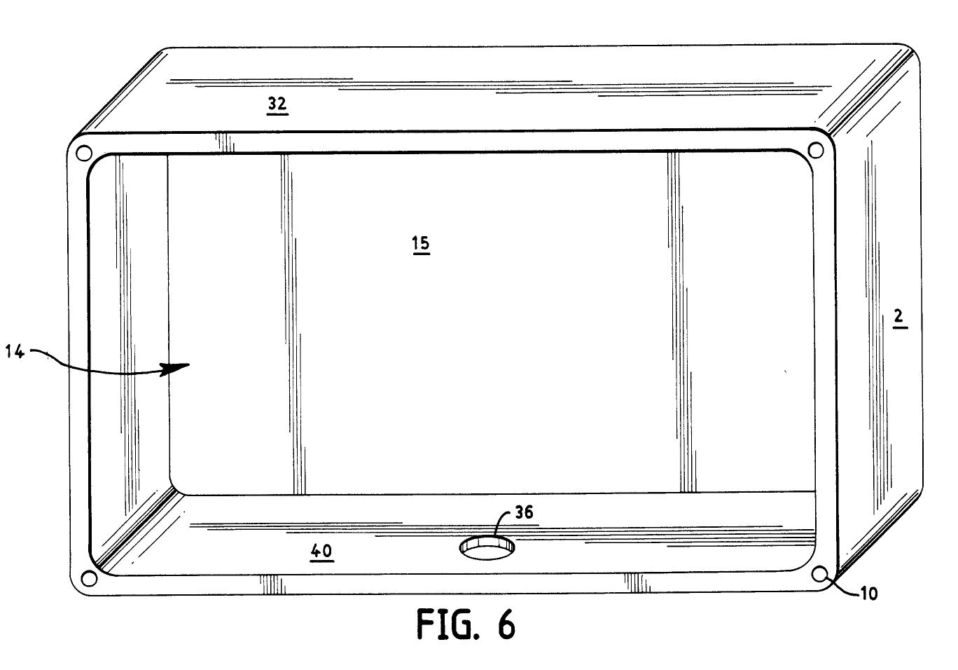

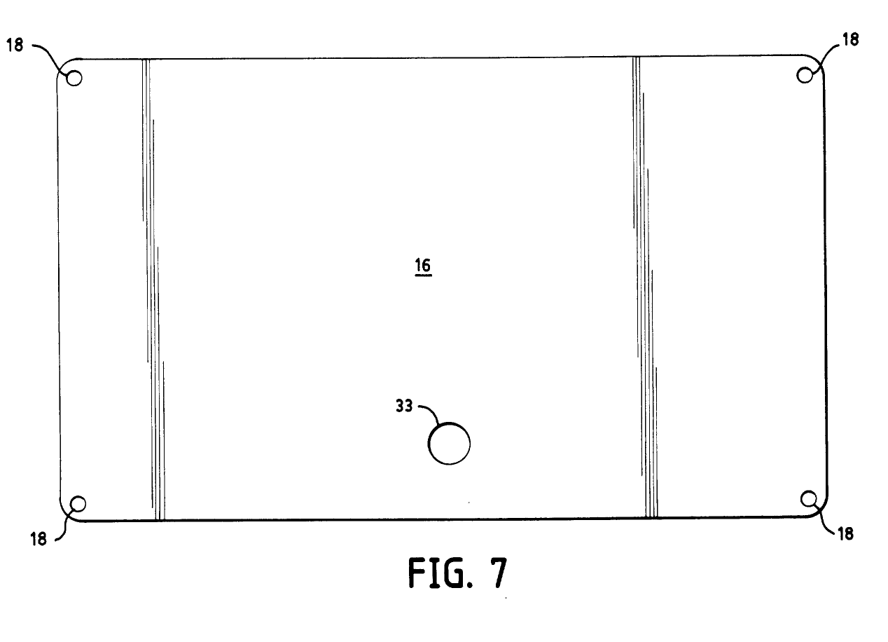

The preferred embodiment of the box-like body (2) has been described as having only one open side over which the cover plate and lens are firmly mounted. While a single open side is preferred, it is entirely possible that the side of the box-like body directly opposite the open side may be open as well. As per FIGS. 6 and 7, the box-like body (2) may have the open side over which the cover plate and lens are firmly mounted (14) and the back side (15) of the box-like body opposite and spaced apart from the open side may be open as well. In such a case, it is required that a second cover plate (16) be included and installed in order to prevent the unintended escape of light from within the hollow interior of the box-like body. This pattern of open sides and cover plates may be repeated for each side, if desired, so long as the box-like body retains sufficient stability and strength so that it does not collapse, deform, or otherwise become damaged during handling and use, and so long as at least one side has a portion through which light emitted by the illumination source may escape the hollow interior of the box-like body.

As per FIGS. 1 and 7, and as noted above, the cover plate should be removably attached to the box-like body (2) by means for attachment. In the preferred embodiment, the cover plate has a plurality of means for attachment holes (18) identical to those found in the second cover plate. In the preferred embodiment, the means for attachment are screws (9) which are passed through the means for attachment holes which in turn pass completely through the cover plate. The screws may be removably threaded into corresponding threaded holes (10) located on the box-like body. The threaded holes and the means for attachment holes (18) passing completely through the cover plate must be aligned such that when the device is fully assembled, the screws (9) will securely retain the cover plate and lens portion against the box-like body.

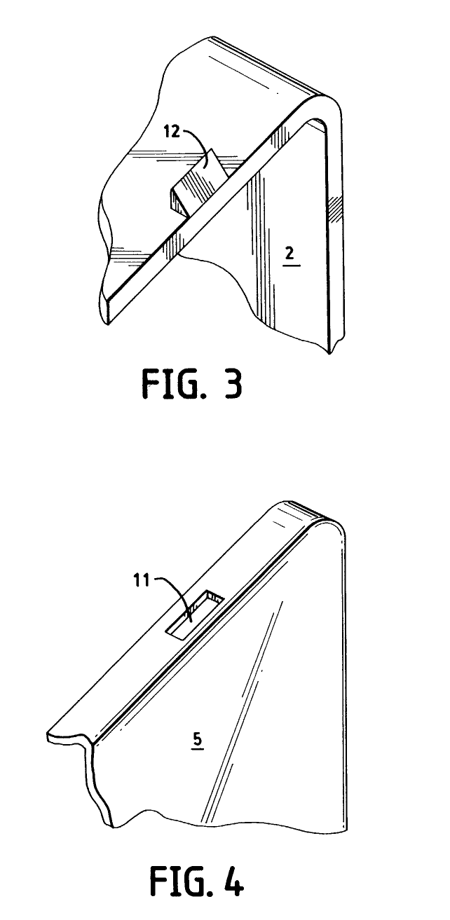

Clearly, while screws may be the preferred means for attachment, other particular arrangements and components would work equally well so long as the cover plate and lens portion may be firmly, but removably, attached to the box-like body. For example, as per FIGS. 3 and 4, the cover plate and lens may be attached to the box-like body (2) via slots (11) and biased tabs (12) which, when fully assembled, are capable of interlocking with one another and securing the cover plate with lens to the box-like body. While it is preferred that when attachment is attained in this fashion, the tabs (12) are located on the box-like body (2) and the slots (11) are located on the cover plate with lens, it is not so required. So long as the cover plate and lens may be removably, but securely attached to the box-like body (2), the invention will function as contemplated by the inventors. Biasing of the tabs may be easily accomplished by conventional methods such as, when the box-like body is to be constructed of rigid plastic, molding the tabs onto the box-like body such that they may be slightly deformable or bendable, but tend to return to their original orientation once the cover plate is in place with the slots aligned so that the tab extends into the slot. This arrangement of somewhat bendable, but generally rigid plastic tabs and slots into which they may fit is well known in the art, and therefore will not be described in great detail. So long as the cover plate may be preferably removably attached to the box-like body, the precise manner for so doing is unimportant for proper operation of the invention.

It is further entirely possible that the device may be constructed such that the cover plate and lens are of one-piece construction. They may further be fabricated from the same material as the box-like body. Furthermore, the lens/cover plate could be formed as a one-piece construction with the box-like body itself. For example, the box-like body having one open side may be fabricated from a translucent plastic which could then be painted or otherwise covered in opaque material. When applying the opaque material, care would need be taken to ensure that the lens portion remained un-covered such that light could pass therethrough from the illumination source. Furthermore, in such a configuration, the box-like body would still need an opening passing through a side (or simply an open side) so that the hollow interior could be accessed for emplacement therein of the illumination source and any necessary power wires and/or switches or other desired elements. Finally, in such a configuration, there would still need to be a cover plate, similar to the second cover plate (16) which would be attached over the opening by means for attachment. Again, so long as light emitted by the illumination source may escape the interior of the hollow box-like body, passing through a portion of the device which is translucent or transparent and serves as the lens, in such a way as to further pass through transparent or translucent data which is to be visible under darkened conditions, the instant invention will function as intended.

In order to practice the instant invention with no experimentation whatsoever, the inventors note that they prefer the assembled device to have a width (6) of approximately 12 inches, a height (7) of approximately 7 inches and a depth (8) of approximately 2 inches. It is believed that these are the ideal dimensions when the invention is used as a lighted house numbering device as it may be easily seen at a distance both in the dark and in daylight, and yet is not so large as to be difficult to handle, mount or place in a suitable location.

Furthermore, when the lens is to be a separate piece from the cover plate, the lens is preferred to be fabricated from a translucent plastic having sufficient thickness and strength so as to remain rigid when in use. This may be easily accomplished by fabricating the lens from a suitable plastic such as “plexi-glass”. The box-like body may be fabricated from plastic as well, or other suitable material such as metal. So long as the device will be sufficiently strong and rigid so as to not deform during handling or use, and so long as the device will not deform, melt or otherwise become damaged due to heat which may be produced by the illumination source while it produces light, the particular material used for construction is unimportant.

In the preferred embodiment, as per FIGS. 1 and 2, when the device is to be used as a lighted, house number identification device, it is useful to include a strobe light (31). Such a strobe fight is beneficial in that it provides the user of the device with a means for quickly alerting those whom might be in view of the device that assistance is needed. Furthermore, in the event that emergency services personnel are searching for the house, the lighted number sign and strobe light in close proximity will maximize the likelihood that the emergency personnel will quickly locate and identify the house having the person or persons in need of assistance.

The manner for including a strobe light in the instant invention is simple and requires little more than the strobe fight (31), a power source for the strobe light, and a strobe light switch (34) with which to activate the strobe light. This may be accomplished as per FIGS. 1, 2, 6 and 7 by preferably mounting the strobe light (31) within the hollow interior of the box-like body. The strobe light is electrically connected to the means for communicating power (35) via a strobe light switch (34). The strobe light switch may be manually operable or remotely operable. The actual choice of particular manually or remotely operable switches requires no inventive skill as both sorts of switches are well known throughout the arts. It is preferred that a remotely operable switch is included as it enables the user to activate the strobe light at a distance, for example, while lying on the floor unable to stand. Because these sorts of remotely operable switches are well known, and include but are not limited to radio frequency, infrared, and audio frequency, the precise details of what sort or type of switch may be included is not set forth in detail herein. It is expected that in the event that a manually operable switch is utilized to activate the strobe light, then it will be necessary to provide for a opening in the hollow box-like body through which such a may be accessed. As per FIG. 7, this strobe light switch access hole (33) could easily be provided by having a hole passing completely through a side of the hollow box-like body in close proximity to the switch. As per FIG. 7, where the device is to incorporate a second cover plate (16), the strobe light switch access hole could easily be located on the second cover plate. In the event that a remotely operable strobe light switch is to be utilized instead of a manually operable one, the strobe light switch access hole could be useful for providing easy access of infrared light or radio waves or any other “triggering” stimulus to the remotely operable switch.

In the event that a strobe light is to be included in a particular embodiment of the instant invention, and that strobe light is to be mounted within the hollow interior of the box-like body, then it is further necessary to provide a means for light to escape the strobe light into the environment beyond the hollow interior. This may most easily be accomplished, as per FIG. 1 by including a lens cut-out area (41). The lens cut-out area should be a hole passing completely through the lens (5), the cut-out area being sized and shaped such that when the device is completely assembled, the cut-out area will overlie the light emitting portion of the strobe light, thereby permitting the passage of light produced by the strobe light through the lens.

Another feature deemed useful by the inventors is a light activated switch (19) which will automatically permit power to reach the illumination source when the ambient lighting conditions are darkened, and discontinue the supply of power o the illumination source when the ambient light conditions are sufficiently lightened. This may easily be accomplished by the inclusion of an ordinary and well known photo-active switch such as a photo-voltaic switch (e.g. a light sensitive, or photo-voltaic switch set to interrupt the flow of power to the illumination source during daylight hours) commonly known in the prior art, the photo-active switch being electrically attached between the power source and the illumination source. As per FIGS. 1, 2 and 8, when configured in this manner, a means for communicating power from a power source (35) to components of the device is simply electrical wiring. The power source itself may be household current from a household electrical receptacle, battery, or nearly any other suitable power source. The means for communicating power from a power source extends through a power cord hole (36), the power cord hole passing completely through a side of the box-like body, the means for communicating power further extending into the hollow interior of the box-like body and providing electrical power to at least the illumination source. Where the photo-active switch (19) is to be included, it should be connected to the means for communicating power such that it interrupt the flow of power to the illumination source. However, if a strobe light is to be included as well, the photo-active switch should be connected to the means for communicating power (“power” being electrical current) such that it will not interrupt the flow of power through the means for communicating power to the strobe light irrespective of whether or not power is flowing through the photo-active switch to the illumination source. This ensures that the photo-active switch will not interfere with the operation of the strobe light.

Furthermore, if a photo-active switch which will control the illumination source is to be included, there must be a way for the ambient light to reach the photo-active switch and operate it. The inventors have found that this is most effectively accomplished, as per FIGS. 1, 2, and 8, by including a photo-active switch light access hole (37) directly adjacent to the light sensitive portion of the photo-active switch. In the preferred embodiment, where a photo-active switch is included, the photo-active switch is mounted in the hollow interior or the box-like body, facing toward the cover plate when the device is fully assembled. The photo-active switch light access hole (37) is located on the cover plate (17), passing completely through the cover plate and permitting ambient light from outside the box-like body to strike the photo-sensitive portion of the photo-active switch. Obviously, the photo-active switch light access hole (37) should be sized, shaped, and aligned so that the ambient light which might be present in the environment outside the box-like body passes through the photo-active switch light access hole and strikes the photo-sensitive portion of the photo-active switch.

Though not discussed in detail, the illumination source (4) for the device, in the preferred embodiment, is a pair of incandescent lights mounted in light fixtures and connected to the means for communicating power from a power source, either directly or indirectly (through a switch). However, while a pair of incandescent lights serves as the illumination source in the preferred embodiment, other illumination sources would work equally well, so long as they are sized and shaped so as to fit within the hollow interior of the box-like body, and do not produce so much radiant energy in the form of heat so as to melt, deform or otherwise damage the box-like body, lens, cover plate and/or thin sheet-like material used to communicate information.

When used as a lighted house numbering device, it is further useful to include device mounting means with the instant invention. As the instant invention may be mounted in a wide variety of locations, the device mounting means chosen will likely be varied according to the needs of the particular location. In the preferred embodiment of the instant invention, the device mounting means are suction cups (20) attached to the cover plate (17) so that the device may be mounted inside a building, against a window such that it is clearly visible outside the house, through the window.

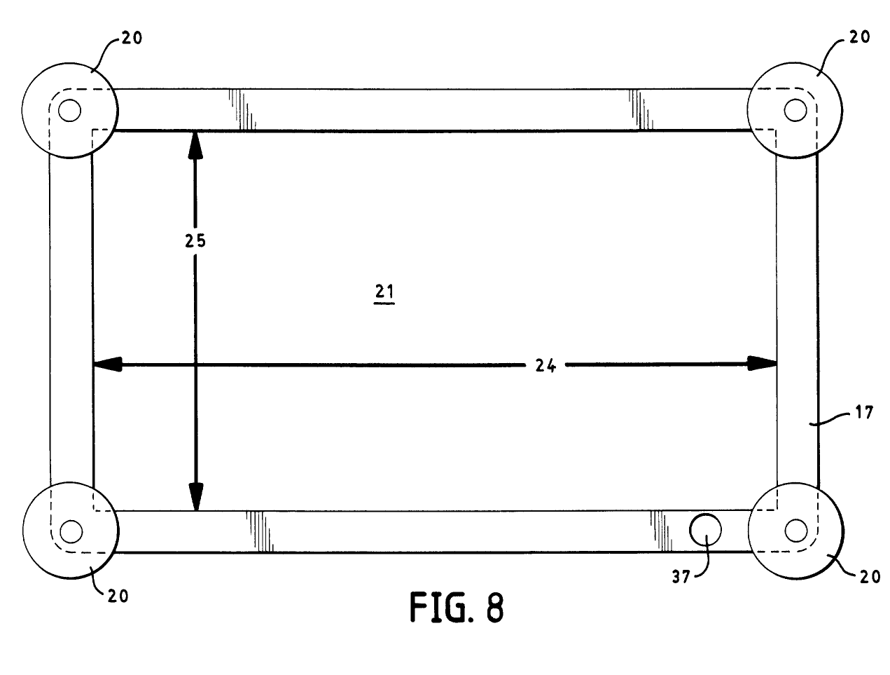

As per FIG. 8, when the device mounting means are to be suction cups, they are preferably attached to the cover plate (17) such that they face way from the cover plate. That is, given that conventional suction cups have an essentially concave portion which, when pressed against a suitable surface forms a vacuum-like attachment between the suction cup and the suitable surface (e.g. a glass window), the suction cup concave portion will face outwardly, away from the lens when the device is fully assembled. The reason for assembly in this fashion, when the device is to serve as a lighted house numbering device, and the device is to be mounted inside a house, is so that the house numbers will face outwardly from the house, so as to be visible outside the house, through the window. The suction cups may be attached to the cover plate (17) using any conventional attachment means such as screws, pins or adhesives such as glue. So long as the suction cups are securely attached to the instant invention such that they will not detach from the invention when carrying the mass of the fully assembled device, the particular type of attachment means is unimportant.

And while suction cups have been described as the preferred device mounting means, other suitable device mounting means may be desired based upon the ultimate location in which the device is to be mounted. For example, if one wished to mount the instant invention on the side of a mail box rather than on a window inside a house, one might use at least one screw or other fastener means to attach the box-like body to the mail box.

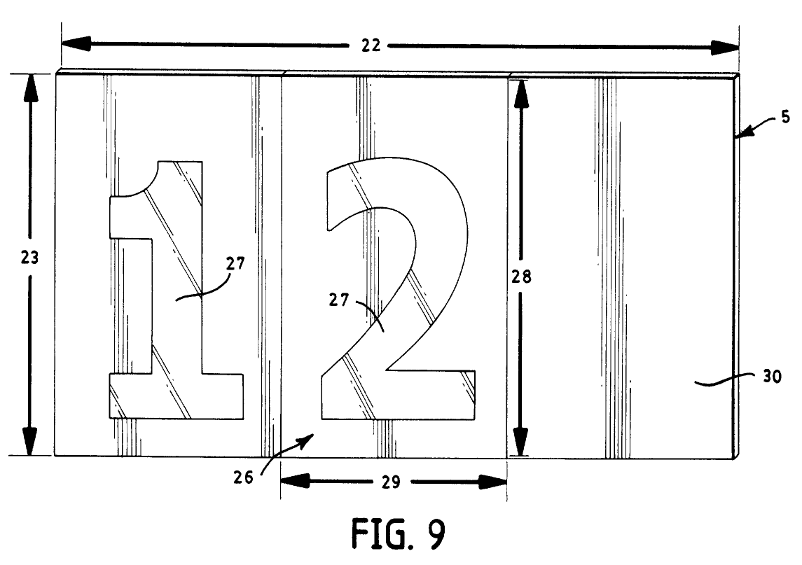

As has been described above, and as per FIGS. 8 and 9, the instant invention is preferred to have the cover plate (17) and the lens (5) as separate components. It has been further explained that when the device is fully assembled, the cover plate (17) and the lens (5) should be securely attached to the box-like body. Where the particular embodiment is to have separate lens and cover plate components, the cover plate (17) must obviously have a cover plate opening (21) passing completely through the cover plate so that the lens will be visible when the cover plate is assembled onto the lens and box-like body (essentially “sandwiching” the lens between the cover plate and box-like body). The lens width (22) and lens height (23) should be greater than the cover plate opening width (24) and cover plate opening height (25) so that the lens is visible through the cover plate opening (21), while at the same time the lens is of sufficient dimensions so as to prevent it from passing through the cover plate opening when fully assembled. An example of such dimensions in keeping with the embodiments described thus far would be for the cover plate opening width (24) to be 11 and ¾ inches and the lens width 922) to be 11 and ⅞ inches, while the cover plate opening height (25) would be 6 inches and the lens height (23) would be 6 and ⅜ inches. The precise measurements may be varied so long as the dimensions of the lens are slightly greater than the dimensions of the cover plate opening so as to prevent the unintended and undesired detachment of the lens from the device when the device is fully assembled.

Finally, the device should include means for communicating information. When the instant invention is to be used as a lighted house numbering device, information to be conveyed is likely to be a house number consisting of at least one numeral. As has been pointed out, the information or data (numeral in this case) is preferably printed on a thin sheet-like material (e.g. MYLAR or other thin, flexible plastic sheet). It has also been noted that in the preferred embodiment, the information to be communicated should be printed on the thin sheet-like material such that maximum contrast is obtained between the information and the background against which the information appears. As per FIG. 9, the inventors have learned that the best way to achieve this contrast is for the background (26) to be opaque (preferably black in color) and the information to be communicated (in this case, the numeral), also known as data (27) to be transparent or translucent. Clearly, the information could be tinted a desired color (such as red) and still be within the scope of the invention contemplated herein. It is also important to note that maximum contrast is achieved when the numeral is transparent and the lens is translucent, preferably a translucent white color. However, the information to be communicated could just as easily be transparent, the lens a color tinted translucent, and still operate as desired. Maximum contrast is desirable in order to make the information to be communicated clearly visible at a distance when the ambient light conditions are not entirely dark, but not fully lightened either (e.g. dusk and dawn).

It is further believed to be important that the dimensions of the thin sheet-like material are such that when the device is completely assembled and ready for use, the thin sheet-like material completely covers the lens. In the example set out immediately above, the lens has a height (23) of 6 and ⅜ inches. Therefore, the thin sheet-like material height (28) should also have a height of 6 and ⅜ inches. The thin sheet-like material width (29) will need to be varied according to the requirements of the information to be communicated. For example, when used as a house numbering device, the numerals necessary to identify the house will define the exact width of the thin sheet-like material. This is due to the fact that there may be as few as one numeral (in which case the thin sheet-like material width should be equal to the lens width, 11 and ⅞ inches), or a plurality of numerals (as in the address “123 Elm Street” where there are a total of three numerals). Where, for example, there are a total of 3 numerals, the total width of the thin sheet-like material should still be equal to the lens width. The reason for desiring the height of the thin sheet-like material and the width of the thin sheet-like material to be essentially equal to the height of the lens and the width of the lens, respectively, is that the thin sheet-like material should completely cover the lens so that when fully assembled into the completed device, the light produced by the illumination source may only pass directly through the information to be communicated, in this case, the numerals, and should not be permitted to pass through or around the thin sheet-like material background, or between the thin sheet-like material and the cover plate. This ensures that the maximum available light produced by the illumination source passes through the information to be communicated, increasing the visibility of that information under darkened ambient light conditions.

In the preferred embodiment of the instant invention, when used as a lighted house numbering sign, the inventors believe that the most expedient manner for accommodating the varying number of numerals which may be required by each user of the device, while at the same tune ensuring that the entire lens is covered by thin sheet-like material is to include some thin-sheet like material which has no information to be communicated, but is instead completely opaque. As per the example set forth in FIG. 9, the information to be communicated (27) is “12” (or house number 12). IF each numeral is on a separate piece of thin sheet-like material having a width of approximately 4 inches, ten the total width of the two thin sheet-like material pieces would only be approximately 8 inches, less then the lens width of 11 and ⅞ inches. This would be undesirable as it would leave approximately 3 and ⅞ inches of the lens uncovered by thin sheet-like material (as shown in FIG. 1, thus permitting light to escape the device without first passing through the information to be communicated. This is easily avoided by having a piece of thin sheet-like material which is completely opaque (30), having no information to be communicated, but instead being composed of only “background”, the width of which is sufficient to cover the portion of the lens uncovered by the thin sheet-like material having information to be communicated. There may be a slight overlap of the thin sheet-like material pieces onto one another, however, this is preferable to having any of the lens exposed without thin sheet-like material on it.

While this is believed the most expedient runner in which to address the aforementioned problem, it could just as easily be remedied by fabricating thin sheet-like material pieces having varying widths such that when applied in the desired combination, the lens is once again completely covered by thin sheet-like material, and light is permitted to escape from the illumination source to the environment outside the hollow interior of the box-like body only after passing through the information to be communicated, and being prevented from escaping into said outside environment by the opaque background on the thin sheet-like material.

The full operation of the preferred embodiment of the instant invention may now be fully described and understood. After acquiring the device for use as a lighted house number sign, the user would select the appropriate information to be communicated (e.g. numerals printed on thin sheet-like material) and fasten same to the lens. The thin sheet-like material may have a self-sticking adhesive backing, or may need to be glued (preferably using a removable adhesive such as what is commonly known as “rubber cement”) to the lens. The cover plate being securely fastened such that the lens is secured to the box-like body, the device may then be mounted in an appropriate location, such as by using the attached suction cups to secure the device inside a house, against a window, the lens facing outwardly, away from the interior of the house and toward the environment exterior of the house (e.g. toward the street). The instant invention would then be connected to a power source so that the illumination source may produce light which will shine through the lens, through the translucent or transparent portion of the thin sheet-like material, thus making the information to be communicated visible at a distance, even under darkened conditions.

In the event that an emergency occurs, the user of the device may activate the strobe light using either the manual switch or remote switch, depending upon which embodiment the user has. The strobe light will flash intermittently at a high rate (as strobe lights inherently do), thereby drawing further attention to the lighted house number sign and informing those who view the device that attention is needed.

What is claimed is:

1. A customizable back lighted sign comprising;
A. a box-like body,
I. the box-like body having a hollow interior,
II. the box-like body having an open side,
B. an illumination source,
I. the illumination source being mounted in the hollow interior of the box-like body,
II. the illumination source being connected to a means for communicating power from a power source,
C. a lens,
D. a cover plate,
I. the cover plate securing the lens to the box-like body via means for attachment,
II. the lens and cover plate completely covering the box-like body open side,
E. means for communicating information,
I. the means for communicating information being attached to the lens,
II. the means for communicating information having opaque portions and transparent or translucent portions.

2. A customizable back lighted sign according to claim 1, wherein the lens and the cover plate are of one piece construction.

3. A customizable back lighted sign according to claim 1, the means for communicating information further comprising;
A. thin sheet-like material, the opaque portions being background, the transparent portions being data.

4. A customizable back lighted sign according to claim 3, the means for communicating information further comprising;
A. the data being numerals.

5. A customizable back lighted sign comprising;
A. a box-like body,
I. the box-like body having a hollow interior,
II. the box-like body having an open side,
B. an illumination source;
I. the illumination source being mounted within the hollow interior of the box-like body,
II. the illumination source being connected to a means for communicating power from a power source,
C. a strobe light,
I. the strobe fight being mounted within the box-like body, the strobe light being connected to a switch for activating the strobe light, the switch being connected to the means for communicating power from a power source.
D. a lens,
E. a cover plate,
I. the cover plate securing the lens to the box-like body via means for attachment,
II. the lens and cover plate completely covering the box-like body open side,
F. means for communicating information,
I. the means for communicating information being removably attached to the lens,
II. the means for communicating information having opaque portions and transparent portions,
III. the means for communicating information completely covering the lens.

6. A customizable back lighted sign according to claim 5, the means for communicating information further comprising;
A. thin sheet-like material, the opaque portions being background, the transparent portions being data.

7. A customizable back lighted sign according to claim 6, the means for communicating information further comprising;
A. the data being numerals.

8. A lighted house address sign comprising;
A. a box-like body,
I. the box-like body having a hollow interior,
II. the box-like body having an open side,
B. an illumination source,
I. the illumination source being mounted within the box-like body hollow interior,
II. the illumination source being connected to a means for communicating power from a power source,
C. a lens,
D. a cover plate,
I. the cover plate securing the lens to the box-like body open side,
E. means for communicating information,
I. the means for communicating information being removably attached to the lens,
II. the means for communicating information having opaque portions and transparent portions.

9. A lighted house address sign according to claim 8 further comprising;
A. a light activated switch being electrically connected to the illumination source and the means for communicating power from a power source such that the light activated switch controls the operation of the illumination source.

10. A lighted house address sign according to claim 8, the means for communicating information further comprising;
A. thin sheet-like material, the opaque portions being background, the transparent portions being data.

11. A lighted house address sign according to claim 10, the means for communicating information further comprising;
A. the data being numerals.

12. A lighted house address sign according to claim 8, the lens and cover plate being of one piece construction.

13. A lighted house address sign according to claim 8 further comprising;
A. a strobe light,
I. the strobe light being mounted within the box-like body, the strobe light being connected to a switch for activating the strobe light, the switch being connected to the means for communicating power from a power source.

14. A lighted house address sign according to claim 13, the means for communicating information further comprising;
A. thin sheet-like material, the opaque portions being background, the transparent portions being data.

15. A lighted house address sign according to claim 14, the means for communicating information further comprising;
A. the data being numerals.

16. A lighted house address sign according to claim 13, the lens and cover plate being of one piece construction.

17. A lighted house address sign according to claim 8, further comprising;
A. device mounting means for attaching the box-like body to a surface.

18. A lighted house address sign according to claim 17, the device mounting means being at least one suction cup attached to the box-like body.

19. A lighted house address sign according to claim 13, the strobe light switch being remotely operable.

20. A lighted house address sign according to claim 13, the strobe light switch being manually operable.
